(19) United States
(12) Patent Application Publication
(10) Pub. No.: US 2004/0172337 A1
(43) Pub. Date: Sep. 2, 2004

(54) Multi-tier order matching

(76) Inventors: Daniel J. Spoonhower, Pittsburgh, PA (US); Daniel P. Huttenlocher, Ithaca, NY (US); Brian M. Freyburger, New York, NY (US); William J. Rucklidge, Mountain View, CA (US); Tracey Jaquith, Lafayette, CA (US); Walter W. Bell, San Francisco, CA (US)

Correspondence Address: Stephen C. Durant, Morrison & Foerster LLP, 425 Market Street, San Francisco, CA, 94105-2482, US

(21) Appl. No.: 10/378,013

(22) Filed: Feb. 27, 2003

(51) Int. Cl. G06F 17/60

(52) U.S. Cl. 705/26

(57) ABSTRACT

A computer-implemented method of buying and selling items on an electronic marketplace comprising: providing computer readable media encoded with rules that define multiple tiers of an order for a prescribed quantity of an item; wherein a respective rule for a respective tier sets forth a respective bid or offer for the item that is applicable to the respective tier; wherein a respective rule for a respective tier identifies one or more participants eligible to receive a respective bid or offer applicable to the respective tier; and wherein respective rules define prioritization of respective tiers; providing the order over the network while implementing eligibility rules for the tiers so that respective bids or offers are accessible only to respective participants eligible to receive the respective bids or offers; receiving over the electronic marketplace one or more responsive bids or offers to one or more respective provided offers or bids; matching provided bids or offers with received offers or bids in accordance with respective participant eligibility rules so as to provide respective matched bids and offers; evaluating respective matched provided bids and offers for compatibility; resolving resolvable differences between matched bids and offers so as to produce respective compatible matched bids and offers; and executing respective compatible matched bids and offers according to the defined prioritization and up to no more than the prescribed quantity.

### BACKGROUND OF THE INVENTION

In almost any marketplace, a member indicates his or her intention to participate through an order or quote. (Here we use the word order to refer to a quote, bid, offer, market or any other indication of willingness to participate.) Orders typically specify the instrument being traded, the amount (or quantity) of that instrument, the type of transaction desired (i.e. buy or sell), and what compensation is required to complete the transaction. Orders may carry additional information, either explicitly or implicitly, including other constraints (e.g. the period of time for which the order is valid). Orders may be communicated verbally, in written form (e.g. via FAX), or electronically, through email or an electronic communication network (ECN). An ECN is an electronic system that attempts to eliminate third parties orders entered by an exchange market maker or an OTC market maker, and permits such orders to be executed either in whole or in part. ECNs differ from other mechanisms in that they are used to automatically execute orders. In the other mechanisms, transactions are almost always verbally confirmed, then written down or keyed into reporting and settlement systems. In the case of ECNs, once the marketplace has received two compatible orders, it automatically executes a transaction and transmits the resulting execution downstream.

As used herein, an electronic marketplace comprises a computer system which accepts orders over an electronic network, stores orders on computer-readable media and computes matches electronically. It may also transmit current open orders (ranked appropriately) via a network as well as records of past orders and trades previously stored on its media. Marketplaces maybe open to any and all participants or only to select members. Also, they maybe symmetric (in that all participants are treated equally) or asymmetric (in that some participants are treated specially). Many symmetric marketplaces are anonymous (in that the identity of other participants are hidden even after a trade occurs). Participant identity is one of the more important aspects of an asymmetric marketplace: the priviledged participant(s) may be sole holders of the identities of all other participants. Examples of electronic marketplaces include exchanges, both open and member-based (exchanges typically charges fees per transaction or for membership). Electronic marketplaces may also take the shape of a broker/dealer that transmits its markets and accepts orders from its customers electronically. In this later case, the marketplace may be used as a tool to facilitate communication, manage orders, automatically execute trades, and analyze results.

An order typically comprises an identification of the item that to be transacted in, an indication of whether the order is to buy or sell, price and quantity. Of course, additional constraints may be associated with an order such as the time at which it will expire, for instance. The following represents the constituent s of a hypothetical example order to buy a security:

Security (e.g. QQQ)

Direction (e.g. buy)

Price (e.g. $25/share)

Quantity (e.g. 2000 shares)

Many prior ECNs (e.g. Island, Archipelago, Instanet) that have arisen in the last few years have offered electronic trading for equities. The focus of these marketplaces generally tends to be on features like volume and throughput (important in the equities market), rather than on more sophisticated types of interaction that occur in the corporate bond and derivatives markets, for example.

While electronic execution (through ECNs) generally requires less manual work and usually achieves possibly faster execution, it ordinarily does not allow those who place orders to discriminate among other participants. Current verbal mechanisms are less structured and allow for more free-form communication; for instance, a participant may quote different prices offer different quantities to different members of the marketplace. Users may wish to place discretionary orders in order to limit market impact while at the same time getting the fastest possible execution. For example, large or aggressive orders may trigger a shift in the market place, making it more difficult to move a large position.

There is no inherent reason why these discretionary orders must be communicated verbally. However, there currently exists no system to efficiently and flexibly process discretionary orders. One solution to the problem of market impact is the notion of a limited visibility order. For example Islands has developed an automated process to route non-displayed orders to selected parties. Orders are routed to the Island ECN but are not displayed on the Islands limit order book or in a Nasdaq Quote. Islands' non-displayed orders are an implementation of electronic orders with limited visibility. Though such orders address the issue of market impact of large orders, they do not offer any of the more general forms of discretion. That is, the placer, in addition to the parameters listed in the example order above, also typically specifies a single participant or a group of participants who many see this order. The members in a group of participants may be specified, for example, in terms of their market activity such as recent orders or trades. There are at least two problems with this earlier limited visibility approach, however. First, other unintended participants may discover the order by placing small exploratory orders (i.e. “fishing”), and second, the placer may be missing opportunities to trade with other participants (even without exposing a large order). Although the placer may place multiple orders, targeted at different parties, he or she then must manage position risk between the two orders.

Thus, there has been a need for an improved system and process for selective disclosure of discretionary orders and for providing a safe and efficient mechanism for automated execution of such orders at discriminatory prices. The present invention meets this need.

### BRIEF DESCRIPTION OF THE DRAWINGS

FIG. 1 is an illustrative block diagram of one system in which the invention can be implemented.

FIG. 2 is an illustrative block diagram of an alternative system in which the invention can be implemented.

### DETAILED DESCRIPTION OF THE PREFERRED EMBODIMENT

The following description is presented to enable any person skilled in the art to make and use the invention, and is provided in the context of particular applications and its requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the are would realize that the invention might be practiced without the use of these specific details. In other instances, well known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

In traditional marketplaces, an order specifies a single set of constraints as laid out by the placer of the order. Simply put, it states the conditions under which the placer would be willing to participate in a trade. Such orders do not discriminate among other participants; the placer is not allowed to indicate different constraints based upon with whom they will trade with. By contrast, a multi-tiered order in accordance with a present embodiment of the invention allows the owner to specify additional conditions for different counter-parties. Each tier may include a different set of constraints on either a single participant or on a group of participants. A multi-tiered order matcher executes these orders while respecting these additional constraints. Execution of an order is the creation of a trade that satisfies the order. Sometimes the words “execute a trade” are used to identify a trade that satisfies some order.

A multi-tiered order allows a participant to place a single order, backed by a single underlying quantity (or set of quantities in different securities), with different restrictions on different possible resulting executions, depending on the identity of the other participant in the execution.

For example, an order to sell 2000 shares may specify a price of $25 for participant A and a price of 26 for participant B. This would indicate that the user is willing to trade up to 2000 shares total, with some fraction of those shares going to A and another fraction going to B. Moreover, any executions with A must be at a price of at least $25, while executions with B must be at $26 or more.

As used herein, a tier is a set of additional, participant-specific constraints that are appended to an order. For example, each tier may comprise one or more of the following types of constraints:

Target—To whom does this tier apply?

Firmness—Can this tier result in an actual execution?

Visibility—What fraction of the quantity of this order can be shown, if any?

Price—At what price can this tier execute?

Tier information is input to a computer system in order to establish the rules applicable to the order. Different rules apply to different tiers. As indicated above these rules, encoded in a computer readable medium, may specify conditions such as who is eligible to view bids or offers associated with different tiers, whether or not the bids or offers for a given tier are firm offer or mere indications of interest, who is eligible to accept the bids or offers for different tiers, and the prices associated with bids or offers for different tiers.

An order may have many tiers; such an order is called a multi-tiered order. A multi-tiered order matcher as used herein, comprises an electronic mechanism which automatically executes multi-tiered orders. Actual execution can be achieved in an automated fashion just as a traditional ECN executes ordinary orders. A multi-tiered order matcher in accordance with an embodiment of the invention guarantees that the quantity of the item subject to executions is no greater than the original quantity. In other words, it keeps track of executions throughout all tiers so as to not over-commit. In essence, it manages the risk of conflicting trades arising out of bids or offers in different tiers. It further guarantees that each execution is carried out at a price applicable to the particular participants of that execution. In other words, different prices may apply to participants who are targets of different tiers.

Moreover, a prioritization can be specified among tiers. For instance, the encoding of the tier information in electronic media may include an encoding of prioritization or ordering information that indicates that trades with participants eligible for one tier are to take precedent over trades with participants eligible for a different tier.

The firmness constraint a single multi-tier order to provide a mechanism of immediate execution to some parties while indicating only a willingness to execute to other parties.

The multi-tier order matcher is also responsible for selective display of orders: only those participants designated in the tiers should be able to view an order, and then only with the price and quantity specified in that tier.

Moreover, one embodiment of the invention provides a mechanism to resolve the case where there is more than one applicable tier, where a single participant appears in two or more of the tiers. One such mechanism assigns an ordering to the tiers: if a participant is specified in more than one tier, then the constraints that appear in the first applicable tier are used.

An explanation of the operation of the multi-tier order matching in accordance with an embodiment of the invention is as follows:

User A enters an order.

For each tier T in A's order,

For each user B in the target of T, the matcher shows the order to B in a manner consistent with T.

For each open order placed by a user C, the matcher considers an execution between A's order and C's order. There are two conditions used in determine if an execution is possible.

1. There exists a firm tier in A's order whose target set includes C. Call the first such tier T.

2. There exists a firm tier in C's order whose target set includes A. Call the first such tier T'.

There are two potential configurations used in determining if an execution is possible. Note that in any particular implementation, only one of the following two rules would be used.

1. Both Conditions 1 and 2 must be true. The trade executes at the most restrictive price in T and T'. This first configuration is more restrictive in that the set of possible trades is smaller since both A and C must agree. If there is no price that satisfies both conditions, then no execution occurs.

2. Either Condition 1 or 2 must be true, or both. If exactly one is true, then that condition determines the price of the execution. In other words, only one of the two participants needs to agree to the trade. If both are true, some further configuration must be used to compute the trade price. One example is that trade executes at the least restrictive price among T and T'; another is that we use the price of which ever order was submitted first. This second configuration makes sense in asymmetric marketplaces: when one participant (e.g. a broker) is managing the marketplace, it might be feasible to require only one particular participant (e.g. the broker) to agree to a trade.

Executions are processed as for traditional orders: the quantity of each execution is subtracted from the remaining quantity of the order (regardless of the tiers).

### EXAMPLE

Alice places an order over a network to buy 20,000 shares of QQQ. That is, Alice provides the order over a network subject to the rules following rules specified for each tier:

Bob—(Tier_{—}1): 20,000 shares, $25/share, firm

Carol—(Tier_{—}2): 10,000 shares, $24.50/share, indicative

Dave—(Tier_{—}3): 10,000 shares, $23/share, firm

Everyone else—(Tier_{—}4): 2,000 shares, $24.75/share, firm

Initially, what can be seen by each user is exactly as it appear in the tiers. Say that Bob receives the Tier_{—}1 order and counters by providing over the network an order to sell 5,000 shares at $25. This trade can be executed immediately. Alice's and Bob's computer displays for Alice's multi-tier order also can be updated. However, initially, only Alice's and Bob's computers recognize any change in the order. They each receive information indicating an order for 15,000; the computers for all other participant still indicate their tiers as originally provided.

Note, however, that Carol's tier cannot ever be executed, but it might be useful as part of a negotiation process nonetheless. Suppose that Carol had received a firm order rather than an indicative order. Further, suppose that Bob matches with the tiered order offered to Bob before Carol accepted. In that case Alice, presumably no longer would be interested in trading with Carol. Consequently, Alice would have to manually cancel the order with Carol after she trades with Bob. The use of an indicative tier, as shown above, however, permits automatic removal from Carol's view of the market when Alice and Bob execute their trade.

As another possibility, suppose now that Carol and Dave each place an order to sell 10,000 shares at $24.50. Both of these new orders would appear on the limit book (assuming they had no specialized tiers), but neither would execute. In Carol's case, her order can not execute against Alice's because Alice has marked the tier that applies to Alice as indicative. In Dave's case, Alice has specified that she will only trade with Dave at a price of $23 or better. Thus, Dave's order is not compatible with Alice's offer.

Now, suppose that Eve places an order to sell 4,000 shares at $24.75. This order will execute immediately and entirely, even though Eve sees only 2,000 shares. The quantities associated with each tier only affect the quantity *visible* to a particular user or set of users.

The multi-tier order matcher updates the views of the participants such that after Eve's trade, each of users will see the following quantity:

Alice& Bob: 11,000

Carol & Dave: 10,000

Everyone else (including Eve): 2,000

Finally, suppose that Bob places another order for 5,000 shares at $25 and, at the same time, Dave replaces his order with an order to sell 10,000 at $23. the order matcher must determine which of the two matches to consider first. If the matcher chooses Bob's order, then it can execute 5,000 shares between Alice and Bob (at $25), and then 6,000 shares between Alice and Dave (at $23). If the matcher chooses Dave's, then it executes 10,000 between Alice and Dave and 1,000 between Alice and Bob. Note that in either case, the matcher does not trade more than 20,000 shares on Alice's behalf. Multi-tiered orders may also be used not only with single or static sets of users, but also dynamic sets as in a Dynamic Order Matching System.

As an alternative, rather than prioritizing orders based upon rules keyed to the identities of a specific user or of specific users, Alice might specify users with a particular characteristic. For example, Alice might choose to show her entire order only to those users which have been deemed “likely sellers” (and show a smaller quantity to everyone else). This is one mechanism which allows a multi-tiered matching system to be used in an environment when participants are anonymous (and therefore Alice doesn't know Bob's identity) or where there are a large number of users (where discovering Bob's identity may be incredibly costly).

If, for example, Bob was to offer $24.50 per share to sell 10,000 shares, then Bob's order would be compatible with Alice's Tier_{—}1 price of $25 per share to buy. The two orders would overlap. Alice's multi-tier order could have associated rules for resolving such compatibility issues. For instance a rule might specify that an overlap is to be resolved by choosing the lower dollar amount offer.

A multi-tiered order system in accordance with the invention allows users to specify different conditions upon execution for each of tier above (without adding multiple orders), and provides for automatic execution pursuant to those different conditions. A multi-tiered system is especially useful in an asymmetric marketplace: if one special participant (e.g. a broker) knows the identities of the other participants, then he can set the prices visible to each of those participants.

### Operative Environment

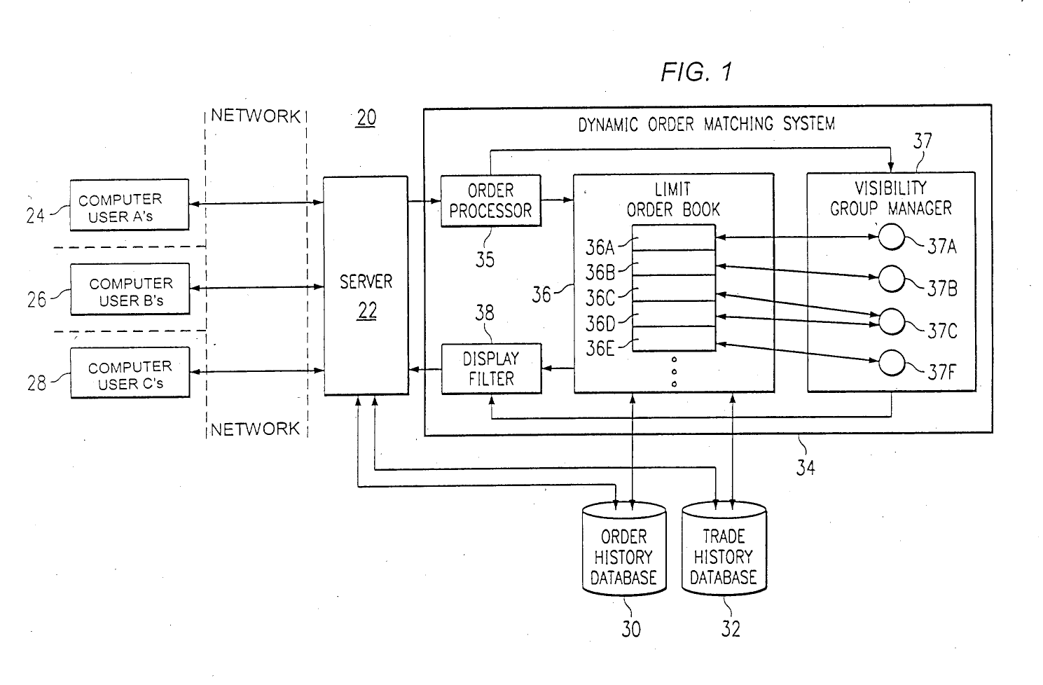

A network for one system to implement a multi-tier order matcher in accordance with the present invention is illustrated in FIG. 1. A system 20 has a network server 22, which works through a variety of networks for connection with user desktop clients such as 24, 26 and 28. The system and method of the present invention may utilize several data files including an order history database 30 and a trade history database 32 which are connected to the network server 22. A dynamic order matching system 34 is included in the system 20 for dynamically matching orders that are entered into the system 20, and for controlling display of these orders on web desktop clients 24, 26, and 28. A dynamic order matching system is described in commonly owned U.S. patent application Ser. No. 09/386,436, entitled Dynamic Order Visibility System for the Trading of Assets, which is expressly incorporated herein in its entirety by this reference. The system 20 enables users to place orders (buy or sell) through their web desktop clients and specify a visibility group of other system users (market participants) who will have access to the order. Further databases, order matching and definitions of visibility groups are described below in detail.

The dynamic order matching system 34 includes an order processor 35 that is connected to the network server 22. The order processor 35 can be programmed to perform multi-tier order processing in accordance with the invention. The processor 35 is further connected to a limit order book 36 and a visibility group manager 37. A display filter 38 is connected to the limit order book 36, the visibility manager 37 and to the network server 22. The function of the display filter 38 is to insure that a given order is made available only to the participants in a selected visibility group. Therefore, it is responsible for constructing the complete list of visible orders for each user.

The limit order book 36 includes specific orders 36A, 36B, 36C, 36D and 36E. Visibility groups, which are designated sets of participants, are included in the visibility group manager 37 as 37A, 37B, 37C and 37F. Order 36A is associated with visibility group 37A, order 36B is associated with visibility group 37B and both of the orders 36C and 36D are associated with the visibility group 37C. Order 36E is associated with visibility group 37F.

The order database 30 and trade history database 32 are further coupled to the limit order book 36.

The dynamic order matching system 34 and its included components, together with the databases 30 and 32, can be implemented in either a single processing system or a distributed system of processors.

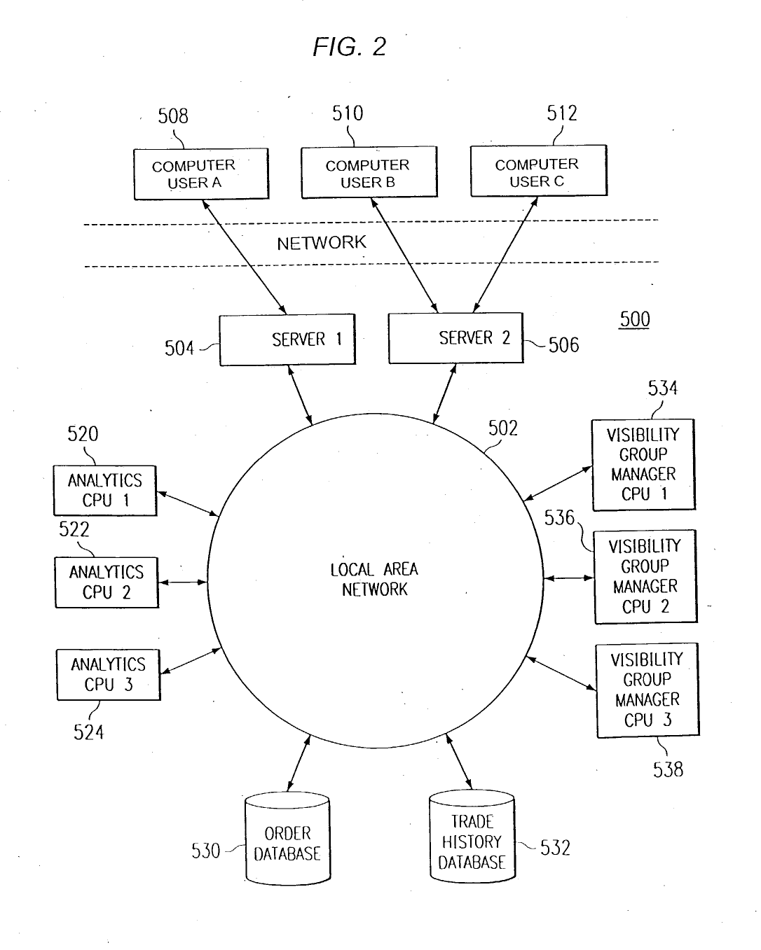

An alternative network 500 to implement a multi-tier order matcher in accordance with the present invention is shown in FIG. 2. This works with the Internet and has user desktop clients 508, 510 and 512 which correspond to the user desktop clients shown in FIG. 1.

A network 500 has network servers 504 and 506 that interconnect the local area network 502 through the Internet to each of the web desktop clients 508, 510 and 512.

Three analytic engines 520, 522 and 524 connect to the local area network 502. In this example, these correspond to the analytic engines 39A, 39B and 39C shown in FIG. 2. The analytics engines can be programmed to perform multi-tier order processing in accordance with the invention. In other configurations, however, there might be multiple analytics engines per CPU, or multiple CPUs per analytics engine. An order database 530 corresponds to the database 30 shown in FIG. 1 and a trade history database 532 corresponds to the database 32 shown in FIG. 1. The network 500 includes three visibility group managers 534, 536 and 538 for generating visibility groups. Although network 500 is a representative hardware configuration of the present invention, the distribution of functions and data storage can be arranged in many different configurations as needed and as determined by the availability of resources for implementing the functions required for the present invention.

It will be understood that the foregoing description and drawings of preferred embodiments in accordance with the present invention are merely illustrative of the principles of the invention. Various modifications can be made by those skilled in the art without departing from the spirit and scope of the invention.

1. A computer-implemented method of buying and selling items on an electronic marketplace comprising:
providing computer readable media encoded with rules that define multiple tiers of an order for a prescribed quantity of an item;
wherein a respective rule for a respective tier sets forth a respective bid or offer for the item that is applicable to the respective tier;
wherein a respective rule for a respective tier identifies one or more participants eligible to receive a respective bid or offer applicable to the respective tier; and
wherein respective rules define prioritization of respective tiers;
providing the order over the network while implementing eligibility rules for the tiers so that respective bids or offers are accessible only to respective participants eligible to receive the respective bids or offers;
receiving over the electronic marketplace one or more responsive bids or offers to one or more respective provided offers or bids;
matching provided bids or offers with received offers or bids in accordance with respective participant eligibility rules so as to provide respective matched bids and offers;
evaluating respective matched provided bids and offers for compatibility;
resolving resolvable differences between matched bids and offers so as to produce respective compatible matched bids and offers; and
executing respective compatible matched bids and offers according to the defined prioritization and up to no more than the prescribed quantity.
